(19) United States
(12) Patent Application Publication
(10) Pub. No.: US 2007/0231398 A1
(43) Pub. Date: Oct. 4, 2007

(54) Antisolvent Emulsion Solidification Process

(76) Inventors: Cornelis Elizabeth Johannus Van Lare, Wijchen (NL); Jozef Johannes Maria Baltussen, Nijmegen (NL); Marianne Frederika Reedijk, Apeldoorn (NL); Boen Ho O, Utrecht (NL)

Correspondence Address: KENYON & KENYON LLP, ONE BROADWAY, NEW YORK, NY, 10004, US

(21) Appl. No.: 11/579,675

(22) PCT Filed: Apr. 21, 2005
(86) PCT No.: PCT/EP05/51777

§ 371 Date: Mar. 5, 2007

Related U.S. Application Data
(60) Provisional application No. 60/567,774, filed on May 5, 2004.

(51) Int. Cl. B01F 3/00

(52) U.S. Cl. 424/490; 264/11; 264/7

(57) ABSTRACT

The invention relates to a process for the controlled production of particles comprising the steps of producing an emulsion comprising one or more compounds to be solidified in its dispersed phase, and dosing a suitable antisolvent to said emulsion, forcing the one or more compounds to solidify. Optionally, the solidified compound(s) is/are encapsulated or coated.

The invention relates to a process for the controlled production of particles from emulsions and is particularly suitable for the production of micro-particles or nano-particles.

Antisolvent solidification is a well-known technique to generate crystals. The size of the obtained crystals influences int. al. the rate of dissolution of a compound and, therefore, trying to control the eventual particle size of a compound is the subject of many research topics. This issue is of particular interest in the area of pharmaceutical product development, since the particle size also influences the ease of segregation in the mixing process which takes place prior to tabletting.

U.S. Pat. No. 4,997,454, for example, describes the advantages of being able to control the crystal size at below 3 microns for drugs that are insoluble in water, as this would allow a safe passage through capillaries without causing emboli. Said document discloses a technique where a compound is dissolved in a solvent/non-solvent mixture, after which an antisolvent is added to this solution at a pre-specified rate, thereby generating a precipitate.

WO 90/03782 describes a process for producing finely divided solid crystalline or amorphous powders. Said process comprises the steps of dissolving a solid in a liquid carrier solvent to form a solution and adding this solution to a volume of antisolvent sufficient to precipitate or crystallise the solid.

As the antisolvent generally a component is chosen that is believed to have a strong interaction with the solvent in which the compound to be solidified is dissolved. Due to this strong interaction, the dissolved molecules tend to aggregate, and subsequently they become insoluble and precipitation occurs. More specifically, an antisolvent induces solidification of a dissolved (organic or inorganic) compound. The antisolvent is typically dosed to the solution held by a vessel (or vice versa) and mixing is performed using an agitator. Drawbacks of such a simple mixing process for the antisolvent and the solvent are that the precipitation process can be so fast that antisolvent is entrapped in the particles and control over the particle size is difficult. It is hypothesised that both nucleation and growth are difficult to control because nucleation occurs at the antisolvent-solution interface, while growth occurs in regions with a lower supersaturation. This may result in the continuous creation of new nuclei and it may lead to uncontrollable size and size distribution of the generated particles. To overcome these problems, special mixing methods are required, such as are for example described in WO 04/096405. In said patent application, it is described that by using a membrane for dosing an antisolvent to a mother liquor or a mother liquor to an antisolvent, improved solidification can be achieved, yielding small, non-agglomerated monodisperse particles.

A method often used in antisolvent crystallisation is the so-called Quasi-Emulsion Solvent Diffusion (QESD) method. This is for instance described in J. Texter, “Organic Particle Precipitation” (Surfactant Science Series. Reaction and Synthesis in Surfactant Systems, 2001, Vol. 100, pp. 577-607). In the QESD method, droplets of solvent with dissolved crystalline material are generated in an antisolvent. Typically, the droplets are generated via high-shear methods, which is a technique well-known in the art of mixing. Once these droplets are formed, the antisolvent diffuses into the droplets, leading to precipitation of the crystals, i.e. the solvent and the antisolvent need to diffuse out of and into the droplets, respectively. The crystals formed are dispersed in the mixture of antisolvent and solvent (diffused out of the original droplets). Sometimes, emulsifiers are added to the antisolvent and/or the solvent to help stabilise the droplets.

The key to said QESD process, however, is that droplets are formed where the antisolvent solution acts as the continuous phase. This is for instance described by M. Nocent et al. in J. of Pharmaceutical Sciences, Vol. 90, No. 10, October 2001, p. 1620. In this method, it is attempted to achieve control over the eventual crystal size by tuning the employed mixing energy, as this controls the droplet size. At the same time, the droplet size is governed by the physical interaction between the solvent and the antisolvent, as this is controlled by for instance the surface tension. However, due to the fact that in the QESD method the emulsification and the antisolvent solidification occur simultaneously, the possibilities for easily controlling the particle size distribution of the compound which is solidified are limited.

U.S. Pat. No. 4,089,843 discloses a process for the conversion of solid polymers to powders in which the particles are substantially spherical and have a uniform size of between 25-75 μm using an emulsion. In this process, the polymer is dissolved in an aprotic solvent, the resulting solution is emulsified in mineral oil, and a minor amount of a liquid precipitant in which the polymer is insoluble is added with agitation. This process is not suitable for the controlled solidification, and preferably the controlled crystallisation, of a wide variety of organic and inorganic compounds while being able to control the particle size over a vast range.

U.S. Pat. No. 6,372,260 describes a process for the incorporation of an active substance in a carrier system by forming an emulsion of the components and precipitating the system by contacting this emulsion with a fluid gas. The active substance which is going to be incorporated into or/and associated with carrier material is dissolved either in the non-aqueous phase or the aqueous phase. The fluid gas can be any material which is in its supercritical or near-supercritical state, as well as a compressed gas. Particle sizes of 1-100 μm are obtained. WO 04/004862 also relates to a method of producing particles of a solute from an emulsion by using a supercritical fluid. However, because of the supercritical fluid functioning as an extractant, large amounts of fluid have to be transported through the emulsion under high pressures to strip or dissolve the solvent from the emulsion droplets and thus to effectuate the solidification of the particles, making the process unattractive for commercial purposes. Another disadvantage of these processes is that the extractant can only be selected from a very limited number of supercritical fluids, since not many known supercritical fluids are practically applicable. As a result, the possibilities for controlling the particle size distribution, the morphology of the particles, the rate of solidification, and the purity of the particles are limited. Furthermore, since particles suspended in the continuous phase are obtained, the possibilities for post-treatment of these particles, such as encapsulation or coating, are limited.

It is therefore an object of the present invention to provide an efficient alternative to the current techniques used to solidify compound(s) in which the particle size of the solidified compounds, their morphology, the rate of solidification, and/or the purity can be easily controlled, and which process is applicable to a variety of compounds. Furthermore, it is an object of the present invention to provide a process which is suitable for the controlled production of nano-sized particles, i.e. particles having a diameter of preferably less than 500 nm. It is also an object of the present invention to provide a process for the solidification of compounds wherein the produced particles can easily be post-treated.

It was surprisingly found that dosing a suitable antisolvent i.e. not a supercritical fluid gas, to a previously prepared emulsion comprising a compound which is to be solidified and which is not an organic polymer, or vice versa, results in a controlled solidification process. More specifically, it was found that by first preparing a, preferably stable, emulsion wherein the product to be solidified is present in the dispersed phase, the average droplet size of the dispersed phase can be controlled, resulting in improved control over the size and shape of the produced particles when an appropriate antisolvent is dosed to said emulsion.

The present invention therefore relates to a process comprising the steps of producing an emulsion comprising one or more compounds which are to be solidified in the dispersed phase, and dosing a suitable antisolvent to said emulsion, or dosing said emulsion to a suitable antisolvent, thus forcing the one or more compounds to solidify. It was found that the formation of the emulsion is an important step, one which presents unique possibilities to control the particle size and the particle size distribution of the resulting particles by tuning the average droplet size of the dispersed phase. Further, the intrinsic chemical and physical properties of the liquids and surfactants making up the emulsion control the interaction of the emulsion with the compound(s) to be solidified and thus the precipitation process. On the other hand, the use of an antisolvent process presents unique possibilities to control the precipitation step itself, e.g. the precipitation rate, the particle size, the morphology of the particles, the purity of the particles, and presents the possibility to make solids which are difficult or even impossible to obtain by reaction solidification, e.g. large organic molecules such as pharmaceutical compounds.

More particularly, in contrast to conventional solidification methods such as the QESD method, or other antisolvent precipitation processes, the process of the invention separates the different stages of the precipitation process, i.e. the mixing of the antisolvent and the creation of local supersaturation in the dispersed phase droplets, instead of performing these stages at the same time. This results in said unique possibility to control nucleation and particle growth, and therefore the possibility to control the size and size distribution of the produced particles. Furthermore, solidification in the process according to the present invention merely occurs within the confined volume of a single droplet made up of a mixture of dispersed phase and antisolvent, thus limiting the possible size of a solidified particle produced in a single droplet to the combined amounts of the compounds to be solidified present in said droplet. As the droplet size of emulsions ranges from the lower nanometer range up to hundreds of nanometers and larger, the particle size of the particles which can be made with this method covers a very broad range. This flexibility is even strengthened by the fact that the antisolvent concentration in the droplet, hence the local antisolvent concentration, can also be varied by modifying the amount of antisolvent dosed to the mixture.

A further advantage of the process according to the present invention is that the use of emulsions is beneficial in the scale-up of the solidification process, as the particle properties are typically related to the emulsion properties and not to scale-dependent process conditions such as mixing and dosing configurations. Yet other advantages of the process according to the present invention are that because the particles are preferably obtained as a suspension inside the emulsion droplets, which is especially the case for emulsions with average droplet sizes of between 5 and 500 nm, these particles can easily be subjected to a post-treatment such as encapsulation or coating or a post-treatment whereby the surface properties of the particles are changed, and the process can be performed at atmospheric pressure and ambient temperature.

With the process of this invention it is possible to make microparticles having a diameter from 0.5 μm up to hundreds of micrometers. Furthermore, the method is particularly suitable for the production of nano-sized particles, i.e. particles having a diameter of preferably less than 500 nm, more preferably less than 300 nm, and most preferably less than 100 nm. It is noted, however, that the actually desired particle size is highly dependent on the intended application of the produced particles.

The emulsion according to the invention is a dispersion of at least two mutually immiscible or partly immiscible liquids comprising one or more compounds which are to be solidified. It may be in the form wherein at least one of the liquids forms the continuous phase while at least one other liquid forms the dispersed phase. It may also be a system comprising a micro-emulsion and/or liquid crystalline phases. Furthermore, the emulsion according to the present invention may also be one or more liquids comprising vesicles, although this is less preferred.

Both phases of the emulsion may contain one or more suitable emulsifying aids or may themselves be an emulsifying aid or have a surfactant function, although this is less preferred. The term emulsifying aid is meant to include any emulsifier, surfactant, wetting agent, or thickening agent conventionally used in the field of emulsification. A liquid having a surfactant function is meant to include any liquid containing covalently attached moieties that facilitate the emulsification of that liquid with another immiscible or partly immiscible liquid. The emulsion according to the present invention may further contain adjuvants such as solids, additional liquids, or dissolved gases.

As already mentioned, the one or more compounds to be solidified are dissolved in the dispersed phase of the emulsion. In a preferred embodiment, only one of the compounds that are dissolved in the dispersed phase is solidified. In another preferred embodiment, only one compound to be solidified is present in the dispersed phase. It is noted that for micro-emulsions or liquid crystalline phases, the skilled person cannot always point out which is the continuous phase and which the dispersed one. Nevertheless, also these types of (micro-)emulsions are suitable for use in the process according to the present invention. It is noted that when the distinction between phases cannot be made, the phase in which the one or more compounds to be solidified are dissolved is denoted as the dispersed phase throughout this specification.

It is noted that for emulsions comprising vesicles, the compound(s) is/are dissolved inside these vesicles.

In a particularly preferred embodiment of the present invention, a (micro)-emulsion is used comprising a well-defined dispersed phase and a well-defined continuous phase.

In a preferred embodiment, the dispersed phase of the emulsion according to the invention is at least 0.01% in weight fraction, based on the total weight of said emulsion, preferably at least 1% in weight fraction, more preferably at least 2.5% in weight fraction, and most preferably at least 5% in weight fraction, based on the total weight of said emulsion. At most, the dispersed phase is preferably 98% in weight fraction, based on the total weight of said emulsion, more preferably at most 90% in weight fraction, even more preferably at most 80% in weight fraction, and most preferably at most 70% in weight fraction, based on the total weight of said emulsion.

The emulsions according to the present invention can be prepared by traditional methods using colloid mills, rotor-stator systems, and homogenisers, as described in for example DE 3818453 A1 and U.S. Pat. No. 4,773,883. In this type of apparatus a mixture of mutually immiscible or only slightly miscible liquids passes through a space with intense agitation. Due to the high shear forces exerted on the mixture, small droplets are created. This method is known as high-shear emulsification. In general, the droplet size is a decreasing function of the energy dissipation in the process. The emulsions can also be prepared by using micro-fluidisers or by using sonic or ultrasonic methods. A summary of suitable emulsification methods can be found in “Formation of Emulsions”, by Pieter Walstra, in Encyclopaedia of Emulsion Technology, Vol. 1, Marcel Dekker, 1983, New York, pp. 64-67.

Emulsions suitable for use in the process according to the present invention can also be made by membrane emulsification, as is generally known to the skilled person. The term membrane as used throughout this specification can denote any conventional membrane having an average pore size of at least 0.1 nm, preferably of at least 0.2 nm, more preferably of at least 0.5 nm, most preferably of at least 1 nm in diameter, and having an average pore size of at most 10 mm, preferably of at most 5 mm, more preferably of at most 1 mm, even more preferably of at most 50 μm, and most preferably of at most 25 μm. The term membrane as used throughout this specification is also meant to include, for example, other perforated objects such as sieves, dead end filters, or perforated plates, as long as they comprise holes having a diameter of between 0.1 nm and 10 mm, more preferably of between 0.2 and 1 mm, and most preferably of between 0.5 nm and 50 μm. Furthermore, the term membrane includes dense polymeric membranes such as pervaportion and reverse osmosis membranes. Preferably, however, use is made of conventional membranes selected from the group consisting of nano-filtration membranes (0.8 nm up to 9 nm pores), ultra-filtration membranes (3 nm up to 100 nm pores), micro-filtration membranes (50 nm up to 3 μm pores), and particle-filtration membranes (2 μm up to 50 μm pores).

Said membranes can have any possible shape. Typical shapes are tubes, fibres, plates, sheets, spiral wounds, etc. Preferably, the membrane has a tubular shape. The pores of the membrane can have any kind of shape, including for example a round shape, square shape, slit shape or irregular shape. Preferably, the pores have a more or less round shape. The membrane can also consist of needles, tubes or hollow fibres running across a wall which is situated between a first liquid medium and a second liquid medium, as a result of which droplets of said first liquid medium are produced in said second liquid medium, at least as long as those needles, tubes or hollow fibres have openings with an average diameter in the range of 0.005 μm to 1,000 μm, preferably smaller than 100 μm, more preferably smaller than 10 μm, and most preferably smaller than 5 μm.

The characteristics of the final emulsion can be influenced by selecting separating means with a particular pore size distribution, for example by using a membrane with a narrow pore size distribution producing droplets with a narrow droplet diameter distribution.

For example, a method for making emulsions with the aid of microfiltration membranes is disclosed in EP 0 765 896 A1. The advantage of preparing emulsions via such a method is that emulsions with a narrow droplet size distribution can be made. Although EP 0 765 896 merely describes a cross-flow emulsification process, it is also possible to make emulsions with membranes using the so-called “pre-mix” or “dead-end” emulsification technology as described by J. P. Altenbach-Rehm, Ghemie-Ingenieur-Technik, Vol. 74, issue 5, 2002.

In another embodiment of the invention, the emulsions are prepared by phase inversion emulsification, as is known to the skilled person. Phase inversion emulsification is an alternative technique for making emulsions wherein a first liquid is mixed into a second liquid in a stirred tank, making an emulsion of the first liquid in the second liquid. By changing the conditions of the emulsion, e.g. the temperature, the surfactant composition, or adding more of the first liquid, the emulsion is inverted, thus creating an emulsion of the second liquid in the first liquid. An example of this method can be found in U.S. Pat. No. 6,165,320. Furthermore, examples of phase inversions can be found in the article “Phase inversion in non-ionic surfactant-oil-water systems, Part 1: The effect of transitional inversion on emulsion drop sizes” by B. W. Brooks and H. N. Richmond, in Chemical Engineering Science, 49, (1994), pp 1053-1064.

Another, preferred, class of emulsions suitable for use in the process according to the invention are the so-called micro-emulsions. Micro-emulsions are thermo-dynamically stable emulsions. They can be made without or with only a minimum of mechanical agitation, see e.g. Holmberg, Handbook of Applied Surface and Colloid Chemistry, John Wiley & Sons, (2001), Ch. 4. Typically, the average droplet size of micro-emulsions lies in the range of 5-200 nm, which makes them attractive as a precursor for nanoparticles. Micro-emulsion systems can be complex. As is known to the skilled person, they can for example be bicontinuous or may comprise liquid crystalline or sponge-like phases.

In another embodiment of the present inventions the emulsion is a vesicle system. Such a system can be prepared via any conventional preparation technique known to the skilled person (see for example Holmberg, Handbook of Applied Surface and Colloid Chemistry, John Wiley & Sons, (2001), Ch. 3). Preferably, a premix of a suitable first liquid as defined below in which the compound(s) which is/are to be solidified is/are dissolved and a suitable vesicle-generating agent is prepared, which subsequently is properly treated to give vesicles. Suitable vesicle-generating agents are surfactants and surfactant mixtures forming lamellar structures in said suitable solvent. A well-known vesicle-forming system is an aqueous mixture of lipids. Well-known methods of making vesicles include mechanical treatment, such as ultra-sonic treatment, dialysis, and evaporation techniques in which the vesicle-forming agent is dissolved in a volatile adjuvant solvent prior to application. Preferably, a vesicle system as concentrated as possible is prepared. Subsequently, the vesicles are preferably separated from the original supernatant, i.e. the continuous phase, by employing well-known techniques such as (ultra)centrifuge, (membrane) dialysis, or chromatography, after which the thus obtained vesicles are to be diluted with a second liquid. Solidification of the compound(s) present in the vesicles is achieved by dosing an antisolvent according to the present invention to the vesicles. An advantage of this system is that only one type of liquid can be used, instead of the two liquids required for conventional emulsions.

Finally, another class of emulsions which can be used in the process according to the present invention are liquid crystalline phases, e.g. smectic or nematic liquid crystalline phases. They can be prepared in any conventional manner known to the skilled person.

As discussed above, the emulsions according to the present invention may comprise one or more suitable surfactants, since the addition thereof can promote the formation of an emulsion. Furthermore, the presence of surfactants can help to stabilise the emulsion. A stabilised emulsion can be stable for a long time without mechanical agitation, although such an emulsion does not need to be thermodynamically stable. Normally, the use of a surfactant will result in an emulsion with a smaller average droplet size. Suitable surfactants for use in the present process include any surfactant conventionally used for preparing and stabilising emulsions, including non-ionic, anionic, cationic, Zwitterionic, amphoteric, or polymeric surfactants. Other stabilising agents such as protective colloids may also be used. Preferably, the surfactant is selected from the group consisting of soap; alkyl sulfates (e.g. sodium dodecyl sulfate); alkyl ether carboxylates; alkyl benzene sulfonates; esters of phosphoric acid; sulfosuccinates; ethoxylates (e.g. alcohol ethoxylates, alkylphenol ethoxylates, ethylene oxide/propylene oxide block copolymers); sorbitan monooleate (e.g. Span 20, 40, or 80 ex Uniqema or Aldrich); polysorbates (e.g. Tween 20 or 80, ex Uniqema or Aldrich); alkylpolyglycosides; quaternary ammonium salts (e.g. dialkyldimethyl quaternary ammonium salts); ester quaternary ammonium salts; carboxybetaines; polyvinyl alcohols (PVAs); ethyl hydroxy ethyl cellulose (EHEC); poly(ethylene oxide); polyethylene glycol; and colloidal particles (e.g. colloidal silica, Mg(OH)₂).

The liquids which can be used for preparing the emulsion according to the present invention may be organic or inorganic. Preferably, alkanes; alcohols; ethers; esters; aromatic solvents such as benzene, toluene, xylene; petroleum ether; water; glycols; and diols are used. The first liquid, i.e. the liquid which will form the dispersed phase, needs to be selected such that the component to be solidified has adequate solubility in the liquid phase to be dispersed. By adequate solubility is meant that, in a preferred embodiment, the concentration of said component in the liquid phase to be dispersed is at least 0.1 g/l, more preferably at least 0.2 g/l, and even more preferably at least 1 g/l. The optimum concentration of the component(s) to be solidified in the liquid phase, however, is dependent int. al. on the antisolvent(s) used, the properties of the component(s), the desired purity of the solid composition, and in the case of a crystalline composition, the desired crystal size. The selection of this liquid can be based on a solubility screening of the compound and/or be made via computations such as with COSMOTHERM (vide infra).

The second liquid, i.e. the liquid which will form the continuous phase, needs to be selected such that it will be able to form an emulsion with said first liquid, optionally with the aid of one or more surfactant(s), without causing said compound(s) to solidify. In principle, this can be any combination of first and second liquids, as long as the continuous phase does not dissolve in the dispersed phase and as long as no undesired solidification occurs.

Preferably, a first liquid is used wherein at least 100 times, more preferably at least 300 times, most preferably at least 1,000 times the total amount of the compound(s) to be solidified that is soluble per ml of the second liquid at 25° C. can be dissolved per ml of said first liquid at 25° C. In a particularly preferred embodiment, the compound(s) is/are not soluble in the second liquid at all.

The solidification process according to the present invention can be used to prepare a composition comprising solid particles comprising organic and/or inorganic compounds, wherein said solid particles are either amorphous or crystalline. Amorphous particles are particles which have no crystal structure (see Webster's 3^{rd} New International Dictionary, Merriam-Webster Inc., 1993, p. 72), whereas crystalline particles are precipitates of solid matter in which the individual molecules are ordered in a regular pattern within crystalline domains. The particles generated can be composed of crystals or fragments of crystals. Such crystals can be monomorphous, i.e. consisting of only one (poly)morphic form, or an isomorphous mixture (see Webster's 3^{rd} New International Dictionary, Merriam-Webster Inc., 1993, p. 72), i.e. comprising more than one (poly)morphic form. In the latter case, the several polymorphs in the crystal can be separated by amorphous regions. In a preferred embodiment the crystals are monomorphous, i.e. they only consist of one (poly)morphic form. It is furthermore noted that the term amorphous also includes a glass-like state.

Compounds suitable for solidification via the process according to the present invention are for example organic compounds such as pharmaceutical or technical chemicals, or inorganic compounds such as alkali or alkaline earth metal salts or heterogeneous catalysts or catalyst intermediates or catalyst additives. The compound preferably does not include an organic polymer, it being noted that the term polymer is used in its original meaning, viz. an organic compound having a molecular weight distribution. Preferably, the organic or inorganic compound is selected from the group consisting of transition metal compounds, transition metal salts, alkali salts, alkaline earth salts, chelating compounds, fatty acids, proteins, cellulose derivatives, surfactants, silicates, chlorates, alkali or alkaline earth salts of carboxylic acids, saccharides, aminoacids, (mixed) metal (hydro)oxides such as alumina (hydro)oxides or magnesium (hydro)oxides, all types of synthetic clays such as hydrotalcite, and pigments.

Particularly preferred compounds include Ba-based salts, Ce-based salts, Ti-based salts, Al-based salts, Mg-based salts, EDTA-salts, FeCl₃, silica, and organic peroxides.

In one preferred embodiment, the organic and/or inorganic compound(s) which are to be solidified using the antisolvent process according to the present invention are pharmaceutical compounds. By pharmaceutical compounds are meant compounds which can be used in the treatment of the human or animal body by surgery or therapy or in diagnostic methods practised on the human or animal body, including compounds used in prophylactic therapy and compounds used in contraception. In one further embodiment also intermediates of such pharmaceutical compounds are considered pharmaceutical compounds. Generally, pharmaceutical compounds require authorisation of the appropriate authorities before they can be marketed as a medicine in a specific country.

The pharmaceutical compound can be present as free base, its corresponding ester, or as a pharmaceutically acceptable salt. Examples of pharmaceutically acceptable salts include maleates, chloride or bromide salts, acetates, sulfates, phosphates, nitrates or propionates.

It is noted that in the process of the present invention it is also possible to first prepare the one or more compounds to be solidified in situ by adding a first reactant to an emulsion comprising another reactant under the formation of said compound(s) to be solidified. Subsequent addition of one or more suitable antisolvents to the emulsion comprising the in-situ formed compound(s) results in its/their solidification.

The average particle size of the compound(s) solidified after addition of a suitable antisolvent to the emulsion according to the present invention preferably is less than 50,000 nm. More preferably, the average particle size of the solidified compound(s) is less than 5,000 nm, even more preferably less than 500 nm, and most preferably less than 100 nm. Preferably, the average particle size of the solidified compound(s) is at least 3 nm, more preferably at least 5 nm, even more preferably at least 7 nm, and most preferably at least 10 nm. The particle size is most conveniently determined by SEM microscopy analysis.

The concentration of the one or more compounds to be solidified in the one or more liquids which form the dispersed phase of the emulsion according to the present invention preferably is close to saturation. Hence, preferably at least 50% of the maximum amount of one or more compounds which can be dissolved in said liquid(s) is present in said dispersed phase. More preferably, at least 70% of said maximum amount of the one or more compounds is present, and most preferably at least 80% of said maximum amount of the one or more compounds is present in the liquid. The optimum concentration, however, depends int. al. on the antisolvent used, the physical properties of the one or more compounds to be solidified, the liquids used, the desired rate of particle growth, the purity of the compounds, the desired purity of the resulting precipitate, and the particle size.

According to a non-binding theory, solidification of the one or more compounds dissolved in the dispersed phase occurs in the emulsion droplets upon entry of the antisolvent into said droplets. The compound(s) that is/are solidified will solidify in either a crystalline or an amorphous state. Preferably, it/they will solidify in a crystalline state.

It is possible that the antisolvent has an effect on the droplet size of the emulsion and by that mechanism has an effect on the particle size of the solid material. However, it was found that the addition of a suitable antisolvent according to the present invention does not inherently interfere with the stability of the emulsion, e.g., it preferably does not cause phase separation. If this were to occur, the particles would be much larger due to uncontrollable coalescence of the emulsion droplets.

The desired average droplet size of the dispersed phase in the emulsion, or in the case of a vesicle system, the desired average vesicle size, according to the present invention can be obtained by selecting the appropriate method of preparation as discussed above, and/or by adding one or more suitable surfactants. Preferably, the average droplet size of the dispersed phase in the emulsion according to the present invention or, in the case of a vesicle system, the average vesicle size, is less than 100,000 nm. More preferably, the maximum average droplet or vesicle size is less than 10,000 nm, even more preferably less than 1,000 nm, and most preferably less than 200 nm. The average droplet or vesicle size preferably is at least 5 nm, more preferably at least 7 nm, and most preferably at least 10 nm.

In ideal cases, i.e. when no coalescence of the droplets in the emulsion occurs and when the particles produced in different droplets do not agglomerate, the average particle size obtained typically depends on the droplet size of the prepared emulsion. Therefore, preferably, an emulsion is prepared having an average droplet size of the dispersed phase which is in the same order of magnitude as the desired average particle size. However, if coalescence and/or agglomeration occur, deviations are expected to occur. In a preferred embodiment, it is possible to produce more particles within one droplet by using a suitable suspending agent, thus reducing the particle size with respect to the droplet size of the emulsion.

The term antisolvent as used throughout this specification is meant to denominate any liquid or mixture of two or more liquids which differs in chemical composition from the liquids employed in the emulsion according to the present invention and which, after being mixed at 20° C. in a 1:1 weight ratio with the emulsion comprising a dissolved compound to be solidified in its dispersed phase, will lower the solubility of said compound to such an extent that within 24 hours, preferably within 12 hours, more preferably within 1 hour, even more preferably within 15 min, and most preferably within 2 min after mixing, at least 5 wt % of the total amount of the compound dissolved in the dispersed phase, preferably at least 15 wt %, and most preferably at least 25 wt %, will have solidified. It is noted that the antisolvent is not a supercritical fluid nor a fluid gas. Preferably, the antisolvent is one single liquid instead of a mixture of liquids.

To achieve solidification of compounds dissolved in the dispersed phase of an emulsion by using a liquid composition, the solubility of the compound in the antisolvent will preferably be substantially lower than in the liquid forming the dispersed phase. Preferably, the amount of compound dissolved in a saturated solution of said compound in the antisolvent is at least 10% less in weight fraction than the amount dissolved in a saturated solution of said compound in the liquid employed as the dispersed phase, at a temperature of 20° C. Preferably, the amount of dissolved compound is at least 30% less in weight fraction, and most preferably the amount is at least 50% less in weight fraction than the amount of compound dissolved in a saturated solution of said compound in the employed dispersed phase. In addition, the presence of the antisolvent in the mixture of the liquids initially forming the emulsion, the compound to be solidified, and the antisolvent can reduce the solubility of said compound in said mixture to such an extent that even after correction for the increased volume of the resulting mixture after the addition of the antisolvent to the emulsion, the total amount of compound to be solidified dissolved in said mixture is lower than the amount of said compound which was dissolved in the dispersed phase before the addition of the antisolvent. This can be illustrated with the following, non-binding example: an emulsion comprises 100 g of a compound to be solidified. To this emulsion, 1,000 g of an antisolvent are added. If the solubility in the resulting mixture comprising both antisolvent and the liquids initially making up the emulsion is, for example, 25 g per 1,000 g of said mixture, 50 g of the compound will solidify. If the solubility of the compound in said mixture of liquids initially forming the emulsion and antisolvent had been 50 g per 1,000 g, no solute would have solidified, as the total amount of liquid media (2,000 g) would have been enough to dissolve 100 g of the compound.

The amount of compound to be solidified which can be dissolved in an emulsion/antisolvent mixture cannot be predicted using the solubilities in the pure emulsion and the pure antisolvent. As is known by the skilled person, this can be determined experimentally using emulsion/antisolvent mixtures comprising different emulsion/antisolvent ratios. The results of these experiments can be used to determine which emulsion/antisolvent ratio gives the required yield.

Preferably, the antisolvent used in the process according to the present invention is environmentally harmless, inflammable, non-explosive, non-toxic, non-smelling, non-corrosive, chemically stable, easy to handle, easily available, and/or inexpensive. The choice of the antisolvent is very important for the product quality and the overall process economics. It was found that through the use of COSMOTHERM®, a Chemical Computational tool for calculating the chemical potential of compound(s) to be solidified-solvent systems, the selection of suitable antisolvents will be easier due to the improved chemical understanding.

Preferred antisolvents include alcohols, ketones, carboxylic acids, esters, ethers, alkanes, water, amines, (food grade) quaternary ammonium salts, and ionic liquids. Examples of particularly preferred antisolvents include water, methanol, ethanol, hexane, pentane, polyethylene glycol, choline chloride, ionic liquids comprising (metal) complexes of EDTA, and ferric-gluconate-sucrose complex.

In a preferred embodiment, the antisolvent is used in an amount of at least 1 g per 500 ml of the emulsion comprising the one or more compounds. More preferably at least 50 g and most preferably at least 100 g are used per 500 ml of emulsion. The antisolvent can be dosed to the emulsion in any conventional way, for example by means of a conventional mixing device. It is also possible to add the antisolvent(s) to the emulsion by forcing said antisolvent(s) through a membrane into said emulsion, or vice versa, as described in WO 04/096405. Preferably, the antisolvent(s) is/are added by means of a controlled addition to the emulsion, for example by means of a dropping funnel, tube, nozzle device, or syringe. Preferably, the antisolvent is dosed at a rate of between 0.01 ml per minute and 5,000 ml per minute per 500 ml of the emulsion comprising the compound to be solidified.

The antisolvent is preferably dosed to the emulsion according to the present invention at a temperature between the freezing and boiling points of the employed liquids, more preferably between 5° C. and 35° C., and most preferably at a temperature of between 15 and 25° C. The exact temperature depends on the stability of the emulsion, the freezing and boiling points of the employed liquids, the miscibility of the liquids, the solubility of the compound in the dispersed phase, and the desired rate of crystallisation. Hence, the optimum temperature is highly dependent on the properties of the dispersed phase, the properties of the compound(s) to be solidified, the prepared emulsion, and the antisolvent(s).

In a further preferred embodiment of the present invention, the solid particles obtained by the addition of one or more antisolvents to an emulsion in which the compound(s) was/were present are subjected to a post-treatment such as encapsulation or coating, wherein the particles are encapsulated or coated after their precipitation or crystallisation or simultaneously with their solidification. It is also possible, although less preferred, that capsules containing a liquid core and a solid shell material comprising the compound(s) to be solidified are generated.

Encapsulation is a technique frequently used to generate capsules that typically contain a liquid core material and a shell material that brings consistency to the particle. However, these techniques can also be used to encapsulate pre-formed particles via the process according to the present invention. The encapsulation can for instance modify the colour, shape, volume, apparent density, reactivity, durability, pressure sensitivity, heat sensitivity, and photo-sensitivity of the encapsulated compound(s). Encapsulated particles have many useful functions and have been employed in many different areas, frequently connected with applications in which the contents of the capsule have to be released into the surrounding environment under controlled conditions. Encapsulating compounds which are solidified makes it possible for example to increase the storage life of a volatile compound. Further, the core material in encapsulated compounds can be protected from the effects of UV rays, moisture, and oxygen. Chemical reactions between two active species can be prevented by physical separation due to encapsulation and, finally, finely divided powders can be encapsulated to reduce agglomeration problems.

The shell material used for encapsulation preferably is of a synthetic nature, such as polymeric materials, but also materials such as gelatin and polysaccharides can be used. Said material and also the manner of encapsulation can be easily selected by the skilled person on the basis of the physical properties of the compound(s) to be encapsulated and the intended application.

Typically, the shell walls are prepared by coacervation and/or interfacial polymerisation or reactions using an emulsion as the basis. The emulsion consists of a continuous phase and a dispersed phase and the dispersed phase is encapsulated with the shell material. Phase separation renders the shell material insoluble (e.g. via a chemical reaction) in the continuous phase, due to which it phase separates onto the particle surface. A typical technique used is the so-called coacervation technique as described for example in C. A. Finch, “Micro-encapsulation,” Ullmanns' Encyclopaedia of Industrial Chemistry, 2002, Chapter 4. A review of applications and technology of encapsulated particles in chemotherapeutic engineering can for instance be found in Chemical Engineering Science 58 (2003), 4087-4114 by Feng and Chien. In interfacial polymerisation, two polymers are used: one dissolving in the continuous phase and the other dissolving in the dispersed phase. By reacting the two components on the interface of the droplet, a shell is formed on the surface of the particle, effectively encapsulating the content.

These techniques can also be used to encapsulate pre-formed particles via the process as described in this invention. The particles are formed by adding the antisolvent to the emulsion droplets and after those particles have been formed, an encapsulation process such as coacervation or an interfacial reaction can be performed. This encapsulation process is by no means limited to these techniques, but merely an example of how to encapsulate solid particles.

In a preferred embodiment of the invention, the particles obtained according to the present invention can also be post-treated by being coated with a conventionally used coating material such as one or more alkali metal salts, alkaline earth metal salts, transition metal salts, transition metals, metal oxides, polymers, or polysaccharides, by precipitating said coating component onto the surface. This is different from encapsulation in that with encapsulation the shell applied around the individual particles is entirely closed, whereas with coating only part of the particle surface is covered, for instance with even smaller particles of a coating compound.

Said coating can be achieved by first preparing the particles to be coated via the process according to the present invention. While the particles are still suspended in the emulsion droplets, the coating material dissolved in an appropriate carrier liquid being chosen such that it is able to diffuse into the emulsion droplets, will enter the droplets. Subsequently, the coating material can be precipitated onto the particles by various methods. For example, antisolvent solidification will occur when the solubility of the coating compound in the droplet is sufficiently low, or an additional antisolvent specific for the coating material can be added after the addition of the coating material, leading to precipitation onto the particle. It is also possible to evaporate the liquid mixture inside the droplet, forcing the coating material to precipitate onto the particle surface. In a particularly preferred embodiment, the coating material is dissolved in the antisolvent used for solidification of the compound. Precipitation of the coating material can then be achieved by the methods as described above.

In another embodiment according to this invention, a particle is encapsulated (or the process could also be defined as coating) by modifying the surface properties as a post-treatment of the previously formed solid particles. A modification, for instance via chemical reactions, of the particle surface generates a shell material with newly added functionalities such as an oxidised surface. In this way properties such as hardness, solubility, and shape can be modified and tuned. Moreover, the entire particles can be affected by the post-treatment, yielding new particles with a new chemical composition. Methods to achieve this are for instance a thermal treatment leading to decomposition of the entire particle.

The process as described hereinbefore can advantageously be used to prepare a pharmaceutical dosage form in which the active ingredient is distributed in an advantageously homogeneous manner. Hence, the present invention also provides a pharmaceutical dosage form comprising a composition containing the particles obtainable by the present process. Because of little variation in particle size, this composition furthermore is especially advantageous for use in the preparation of pharmaceutical products for inhalation. In one special embodiment, therefore, such a pharmaceutical dosage form is a product for inhalation. In another embodiment such a pharmaceutical dosage form is a tablet.

The present invention is elucidated by means of the following non-limiting Examples.

### EXAMPLE 1

A mixture was prepared of Span® 80 (Sorbitan monooleate ex Uniqema), hexane, and brine in the amounts mentioned in Table I by slowly adding a solution of Span® 80 in hexane to the brine.

TABLE I

| Amount of | |
|---|---|
| component (g) | Component |
| 25.00 | Span 80 |
| 75.00 | hexane |
| 20.00 | 26 wt % NaCl in H₂O |

The sample consisted of a clear two-layer system. The top layer of this sample was a micro-emulsion of brine in hexane. Subsequently, 10 grams of said micro-emulsion (i.e. the top layer) were mixed with 10 grams of ethanol (>99%). The resulting solidified NaCl was isolated by evaporation of the solvents and studied with SEM. The typical size of the crystals was found to be about 40 nm.

### EXAMPLE 2

An emulsion was prepared by preparing a mixture of 5 wt % of Span® 80 in hexane. A saturated salt solution was prepared by dissolving 26 wt % of sodium chloride in demineralised water. 90 ml of Span® 80-containing mixture was mixed with 10 ml of the saturated salt solution, using an ultraturrax high-shear mixing device at 17,500 RPM for 3 minutes.

To 20 ml of the thus prepared emulsion, 80 ml of ethanol (>99%) was added over 1 minute. A sample of the final mixture was subsequently put under a light microscope for visual inspection, showing that cubic crystals with a size less than 1 micron had been formed.

### EXAMPLE 3

An organic mixture was made of 54 grams of Span® 80, 4 grams of Tween® 20 (sorbitan mono-9-octadecenoate poly(oxy-1,1-ethanediyl) ex Uniqema), and 400 grams of toluene. A salt solution was prepared by dissolving 26 wt % of sodium chloride in demineralised water. An emulsion was prepared by mixing the toluene mixture with 100 ml of the salt solution, using an ultraturrax high-shear mixing device at 13,500 RPM for 10 minutes. This emulsion was mixed with ethanol (>99%) using a micro-T mixing device with internal channels of approximately 100 μm and two HPLC pumps. The ethanol flow through one channel of the T-mixer was equal to 5 ml/min, while the flow of the emulsion through the other channel of the T-mixer was equal to 0.5 ml/min.

Both the emulsion and the NaCl crystals formed in this experiment were analysed by light diffraction. The average diameter of the droplets was found to be about 0.35 μm. The particle size distribution of the NaCl particles produced in this experiment had a distinct peak at 0.5 μm. This result was confirmed by observations with an optical microscope.

### EXAMPLE 4

An organic mixture was made of 8 grams of Span® 20 and 80 grams of Shellsol® H (low aromatic white spirit with a flash point above 61° C. ex Shell Chemicals). A salt solution was prepared by dissolving 10 wt % of sodium chloride in demineralised water. An emulsion was prepared by mixing 20 grams of the salt solution with the total amount of organic mixture, using an ultraturrax high-shear mixing device at 13,500 RPM for 10 minutes.

In order to prevent agglomeration of the NaCl crystals, the emulsion was added to a mixture of 25 ml ethanol (>99%) with 5 wt % of the emulsifier Redicote® EM26 ex Akzo Nobel N.V., while sonification was used. Both the emulsion and the NaCl crystals formed in this experiment were analysed by light diffraction.

The droplet size distribution in the emulsion is characterised by an average droplet size of 1.9 μm and a span of 1.8, whereas the obtained particles are characterised by an average particle size of 1.6 μm and a span of 1.6, where span is defined as (d₉₀-d₁₀)/d₅₀, wherein d50, d10, and d90 an be understood to mean that 50%, 10%, and 90%, respectively, of the particles have a particle size smaller than or equal to the indicated value as determined by conventional laser diffraction technique. This result was confirmed by observations with an optical microscope.

Thus, this example shows that it is possible to make particles with a distribution which is very similar to the droplet size distribution of the emulsion.

### EXAMPLE 5

An organic mixture was made by mixing 200 grams of benzyl alcohol and 10 grams of water with 0.73 wt % of EHEC. A salt solution was prepared by dissolving 26 wt % of sodium chloride in demineralised water. An emulsion was prepared by mixing 50 grams of the salt solution with the organic mixture, using an ultraturrax high-shear mixing device at 13,500 RPM for 5 minutes.

Part of this emulsion was added to a larger amount of ethanol. Both the emulsion and the NaCl crystals formed in this experiment were analysed by light diffraction. The droplet size distribution of the emulsion is characterised by an average droplet size of 8 μm and a span of 1.3. This result was confirmed by observations with an optical microscope. In this particular example several smaller particles are created in a single emulsion droplet.

The droplet size distribution of the emulsion is characterised by an average droplet size of 8 μm and a span of 1.3, whereas the obtained particles are characterised by an average particle size of 0.9 μm and a span of 1.7.

### EXAMPLE 6

The effect of octanol as a co-surfactant was investigated. To this end a mixture was prepared of Span® 80, octanol, Shellsol® H, and a 37% aqueous sodium silicate (Na₂Si₃O₇) solution in the amounts mentioned in Table II.

TABLE II

| Amount of | |
|---|---|
| component (g) | Component |
| 8.3 | Span 80 |
| 8.3 | octanol |
| 25.0 | Shellsol H |
| 4.00 | Na₂Si₃O₇ solution |

The sample consisted of a clear two-layer system. The top layer of this sample was a micro-emulsion of sodium silicate in Shellsol® H. Subsequently, 15 grams of said micro-emulsion (i.e. the top layer) were mixed with 50 grams of ethanol (>99%). The particles thus formed were filtered with a nanofiltration membrane and redispersed in ethanol again. The resulting sodium silicate particles were isolated by evaporation of the solvents and studied with SEM. The SEM images show that the product consisted of almost monodisperse spherical particles with a typical size of about 20 nm.

### EXAMPLE 7

A mixture was prepared of Spans 80, octanol, Shellshol® H, and a 37% aqueous sodium silicate (Na₂Si₃O₇) solution in the amounts mentioned in Table 3.

TABLE III

| Amount of | |
|---|---|
| component (g) | Component |
| 10.0 | Span 80 |
| 10.0 | octanol |
| 30.0 | Shellsol H |
| 12.5 | Na₂Si₃O₇ solution |

The sample consisted of a clear two-layer system. The top layer of this sample was a micro-emulsion of sodium silicate in Shellsol® H.

A second mixture was prepared of Span 80, octanol, Shellsol® H, and a 50 wt % aqueous FeCl₃ solution in the amounts mentioned in Table IV.

TABLE IV

| Amount of | |
|---|---|
| component (g) | Component |
| 10.0 | Span 80 |
| 10.0 | octanol |
| 30.0 | Shellsol H |
| 12.5 | FeCl₃ solution |

The sample consisted of a clear two-layer system. The top layer of this sample was a micro-emulsion of FeCl₃ in Shellsol® H.

Subsequently, the sodium silicate micro-emulsion (i.e. the top layer of the first mixture) was mixed with 0.5 wt % of ethanol. Due to this addition, sodium silicate particles were made, but the micro-emulsion remained stable. Subsequently, the obtained mixture with sodium silicate particles was mixed with the second micro-emulsion containing FeCl₃ (i.e. the top layer of the second mixture). This mixture was placed in an oven of 20° C. at 50 mbar in order to evaporate the water and ethanol. As FeCl₃ is insoluble in Shellsol® H, it crystallised around the silica particles formed in the previous step.

The thus obtained particles were isolated by evaporation of the solvents and studied with SEM. The SEM pictures showed that homogeneous spherical particles were made. Individual FeCl₃ crystals were not found. The typical size of the spherical particles was found to be about 20 nm. The composition of the sample was analysed with EDX (Electron Diffraction X-ray). The spectrum at the location of the particles clearly showed the presence of Fe and Cl, apart from Si and Na, indicating that sodium silicate particles with a FeCl₃ coating were produced in this experiment.

1. A process for the controlled preparation of particles comprising the steps of
producing an emulsion comprising a solution of one or more inorganic or organic compounds to be solidified, but not including an organic polymer, in its dispersed phase and, optionally, one or more adjuvants, such as surfactants, and
dosing an antisolvent to said emulsion, or dosing said emulsion to an antisolvent, so as to force the one or more dissolved compounds to solidify.

2. A process according to claim 1 wherein the dispersed phase of the emulsion has an average droplet size of between 5 and 100,000 nm.

3. A process according to claim 1 wherein the emulsion is a system of one or more liquids comprising vesicles wherein the one or more compounds which are to be solidified are present inside said vesicles.

4. A process according to claim 1 wherein the emulsion is a micro-emulsion.

5. A process according to claim 1 wherein the compound which has been solidified has an average particle size of between 3 and 50,000 nm.

6. A process according to claim 4 wherein the compound which has been solidified has an average particle size of between 3 and 200 nm.

7. A process according to claim 1 further comprising an encapsulation or coating step wherein the compound(s) is/are encapsulated or coated during or after the solidification step.

8. A process according to claim 1 further comprising a post-treatment step wherein the surface properties of the particles are chemically and/or thermally modified.

9. A process according to claim 1 wherein the antisolvent is selected from the group consisting of water, methanol, ethanol, hexane, pentane, polyethylene glycol, choline chloride, ionic liquids comprising (metal) complexes of EDTA, and ferric-gluconate-sucrose complex.

10. A process according to claim 1 wherein the surfactant is selected from the group consisting of soap; alkyl sulfates; alkyl ether carboxylates; alkyl benzene sulfonates; esters of phosphoric acid; sulfosuccinates; ethoxylates; Polysorbates; alkylpolyglycosides; quaternary ammonium salts; ester quaternary ammonium salts; carboxybetaines; polyvinyl alcohols (PVAs); ethyl hydroxy ethyl cellulose (EHEC); poly(ethylene oxide); polyethylene glycol; and colloidal particles.

11. A process according to claim 1 wherein the compound to be solidified is an organic or inorganic compound selected from the group consisting of transition metal compounds, transition metal salts, alkali salts, alkaline earth salts, chelating compounds, fatty acids, proteins, cellulose derivatives, surfactants, silicates, chlorates, alkali or alkaline earth salts of carboxylic acids, saccharides, aminoacids, (mixed) metal (hydro)oxides, all types of synthetic clays, and pigments.

12. Use of the process according to claim 1 in the preparation of a pharmaceutical dosage form.

13. The process according to claim 2 wherein the dispersed phase of the emulsion has an average droplet size of between 5 and 500 nm.

14. The process according to claim 10 wherein the alkyl sulfate is sodium dodecyl sulfate; the ethoxylate is selected from the group consisting of alcohol ethoxylates, alkylphenol ethoxylates, and ethylene oxide/propylene oxide block copolymers; the Polysorbate is selected from the group consisting of Span 20, Span 40, Span 80, Tween 20 and Tween 80; the quaternary ammonium salt is a dialkyl-dimethyl quaternary ammonium salt; and the colloidal particles are selected from the group consisting of colloidal silica and Mg(OH)₂.

15. The process according to claim 11 wherein the (mixed) metal (hydro)oxides are selected from the group consisting of alumina (hydro)oxides and magnesium (hydro)oxides, and the synthetic clay is hydrotalcite.
